(19) United States
(12) Patent Application Publication
(10) Pub. No.: US 2006/0059274 A1
(43) Pub. Date: Mar. 16, 2006

(54) Consumer electronic entertainment center housing including a connections spine with a plurality of outlets, connector paths and converters for organizing and distributing interconnections between consumer electronic components supported in the housing

(75) Inventors: Lane Thomas Holloway, Pflugerville, TX (US); Nadeem Malik, Austin, TX (US); Margues Benjamin Quiller, Pflugerville, TX (US)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 10/943,053

(22) Filed: Sep. 16, 2004

(51) Int. Cl. G06F 3/00

(52) U.S. Cl. 710/2

(57) ABSTRACT

An electronic entertainment center housing that organizes the mass of wiring, adapters and convertors into a user friendly arrangement that permits the insertion and removal of the electronic components supported therein, as well as the tracking of errors in the entertainment center. The housing is adapted to removably support a plurality of different consumer electronic products. There are a plurality of external I/O connection outlets of different types in the housing and there is a connections spine in the housing that includes a plurality of I/O connection outlets of different types, a plurality of electrical connector paths for connecting pairs of the outlets in the spine with each other and a plurality of electrical connector paths for connecting outlets in said spine with the external outlets in said housing. At least one converter in at least one of the electrical connector paths converts an electrical signal input to one of said outlets of the connector path into a different electrical signal output from the other outlet of the connect or path.

### TECHNICAL FIELD

The present invention relates to consumer electronic entertainment products and components, and particularly to home entertainment center housings for supporting and interconnecting a variety of such products and components in an arrangement suitable to the particular needs of the user.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or World Wide Web (Web). The convergence of the electronic entertainment and consumer industries with data processing exponentially accelerated the demand for wide ranging communication distribution channels, and the Web or Internet reached “critical mass” and commenced a period of phenomenal expansion. With this expansion, consumers have direct access to all matter of databases providing a wide variety of entertainment products through related distribution through the Web and like networks. Because of the ease with which entertainment media content is distributed via the Web, it has become a major source of electronic entertainment product content. Virtually all electronic entertainment databases throughout the world are accessible and able to be searched via the Web. This, of course, greatly supplements all of the other standard distribution modes of electronic entertainment media content distribution, including cable and satellite broadcasts or specific distributions of media content via satellite. In addition, specific entertainment product packages such as CDs, DVDs, VCRs and even audio tape cassette recordings are still prominent in the entertainment product marketplace.

In addition, the consumer electronic product technologies have been rapidly improving product quality and driving down costs so that greatly advanced products continually become available to consumers at lower and lower prices. As a result, home entertainment centers, including relatively high quality high definition LCD or plasma displays, DVD players and recorders and CD players and recorders, have become available to all consumers in the general public. Of course, each rapidly emerging generation of new electronic entertainment products will not necessarily render corresponding products in the previous generation as obsolete. Also, for reasons of economy or just for being comfortable with their operable existing products, the consuming public does not switch to the latest generation of electronic entertainment product overnight. The transition is much more gradual.

Because of this mixture of electronic entertainment product generations and types, it is not unusual for the customary home entertainment center or group of components to be interconnected by a mass of intertwined wires, connectors, adapters, spitters and converters that are disorganized and very hard to track down when removal or insertion of electronic components or products is desired or when a component problem arises.

### SUMMARY OF THE PRESENT INVENTION

The present invention provides a solution to the problem by providing an electronic entertainment center housing that organizes the mass of wiring, adapters and convertors into a user friendly arrangement that permits the insertion and removal of the electronic components supported therein, as well as the tracking of errors in the entertainment center. A housing is provided adapted to removably support a plurality of different consumer electronic products. There are a plurality of external I/O connection outlets of different types in the housing, and there is a connections spine in the housing that includes a plurality of I/O connection outlets of different types, a plurality of electrical connector paths for connecting pairs of the outlets in the spine with each other and a plurality of electrical connector paths for connecting outlets in said spine with the external outlets in the housing. At least one converter in at least one of the electrical connector paths converts an electrical signal input to one of said outlets of the connector path into a different electrical signal output from the other outlet of said connector path.

The entertainment center housing may also include an audio receiver supported within the housing, at least one of the electrical connectors paths connecting an outlet connected to the receiver with one of the external outlets, and a plurality of the electrical connector paths connecting outlets connected to the receiver respectively to outlets connected to other consumer electronic products supported within said housing. Similarly, the housing may also include a video receiver supported within the housing, at least one of the electrical connector paths connecting an outlet connected to the receiver with one of the external outlets and a plurality of the electrical connector paths connecting outlets connected to the receiver respectively to outlets connected to other consumer electronic products supported within the housing.

In accordance with another aspect of this invention, one of the external outlets connected to the outlet connected to either the audio or video receiver is in turn connected to an RF antenna.

Also, one of said electrical connector paths for connecting pairs of the outlets in the spine with each other may connect outlets of different types.

There may be included in the connector path connecting said pairs of outlets, a converter converting the connector path operable with the first outlet into a connector path operable with the second different outlet. Similarly, there may be included in the connector path connecting the outlet in the spine with an external outlet, a converter converting the connector path operable with the outlet in the spine into a connector path operable with the external different outlet. There may also be included in at least one of the connector paths, a converter for converting a signal input into an outlet in one of the connector paths into a different signal output from the other outlet in the connector path. For example, this converter may be connected to an external outlet connected to a power supply.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic prospective view of an electronics entertainment center with portions of the housing broken away to partially expose electronic components supported on housing shelves and illustrating a housing wiring plane or spine through which the wiring in the housing is organized;

FIG. 2 is a more detailed front view of the housing spine or back plane through which the wiring could be organized; and

FIG. 3 is a diagrammatic side section of the rear wall of the housing showing illustrative connections to external and internal outlets from the connection spine.

### DETAILED DESCRIPTION OF THE PREFERRED EMBODIMENT

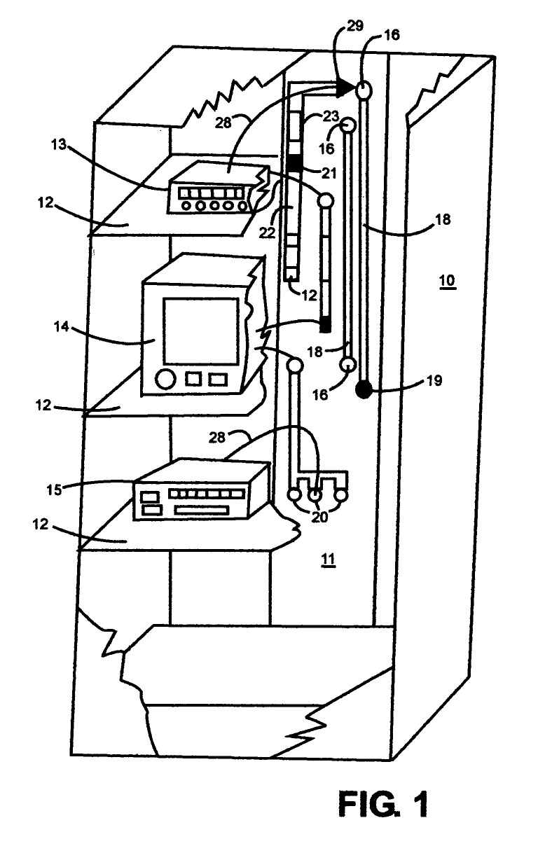

Referring to FIG. 1, an electronics entertainment center with portions of the housing 10 broken away to show wiring spine 11. The housing has shelves 12, upon which electronic entertainment components 13 through 15 are supported. The wiring spine contains a variety of connector paths 18 including or terminating in at least a pair of outlets 16. The outlets may be internal to the spine that is indicated by the outlets being white or at least one of the outlet pair being external to the housing for receiving external I/O input to the components in the housing that is indicated by the outlet being dark. Where the contact outlets are of different types, this is indicated by the shape of the outlet being different. The most common outlet is illustrated by a circular outlet, such as outlet 16 or 20. Different types of contacts are illustrated by square contacts, such as contacts 17 and 21, or triangular contact outlet 29. Usually, if the outlet on either end of a connector path has a different shape, e.g. outlets 17 and 29, this indicates that there may be a converter in the connecting path between such contacts such as converter 23. The connector paths may have more than a pair of outlets, e.g. path 22 has three outlets 17, 21 and 29. Likewise, three outlets 20 are in a single connector path. The electronic components are shown respectively connected to electronic components 13 through 15 via connector lines shown as bold lines. As set forth above, in FIG. 1, for purposes of clearer illustration, when any outlet is shown as dark, e.g. outlet 29, this indicates that the outlet is external, i.e. to the outside of the housing 10.

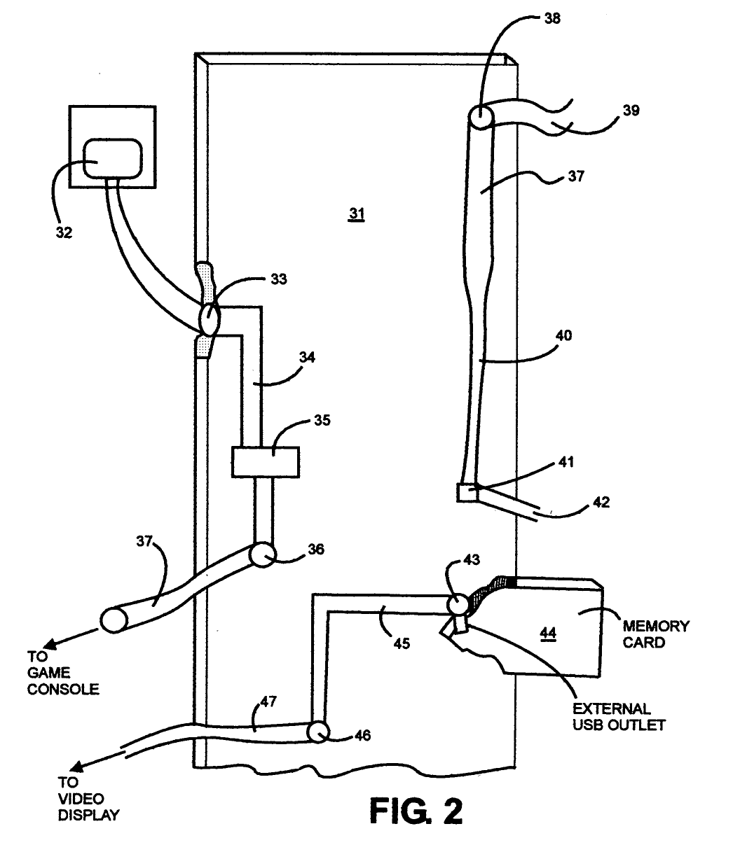

Attention is now directed to FIG. 2 for a more detailed view of the structures described above. Shown is a detailed view of connector spine or back plane 31. A typical internal connection is illustrated by connector path 40 that provides an electrical path between internal outlets 38 and 41 respectively connected to lead wires 39 and 42 to electronic components supported within the housing. It should be noted that there is a significant narrowing of the connector path 37 at area 40 and that outlet 41 (square) is different from outlet 38 (round). This narrowing is meant to illustrate that within connector 37 there is a change in the wiring so that there is conversion from a connector pattern suitable for contact 38, e.g. a RCA contact to a pattern suitable for contact 41 (e.g. an ethernet contact). Other types of contacts that may be thus converted to each other include TCB, S-video, composite, DVI (digital video), Compound video and TOS-link contacts.

There is an adapter 35 built into connector path 34 connecting outside power supply 32 (wall plug) via external outlet 33 through the housing wall via adapter 35 to internal outlet 36, in turn connected via wire lead 37 to a game console. Adapter 35 reduces the 120 volt power supply from the wall plug to a lower level suitable for the game console.

A memory card 44 including, for example, a set of photographs taken on a digital camera may be connected through external USB outlet 43 through the housing wall, then via connector path 45 to internal outlet 46 from which lead wire 47 connects to a video display supported in the housing on which the user may display the photographs.

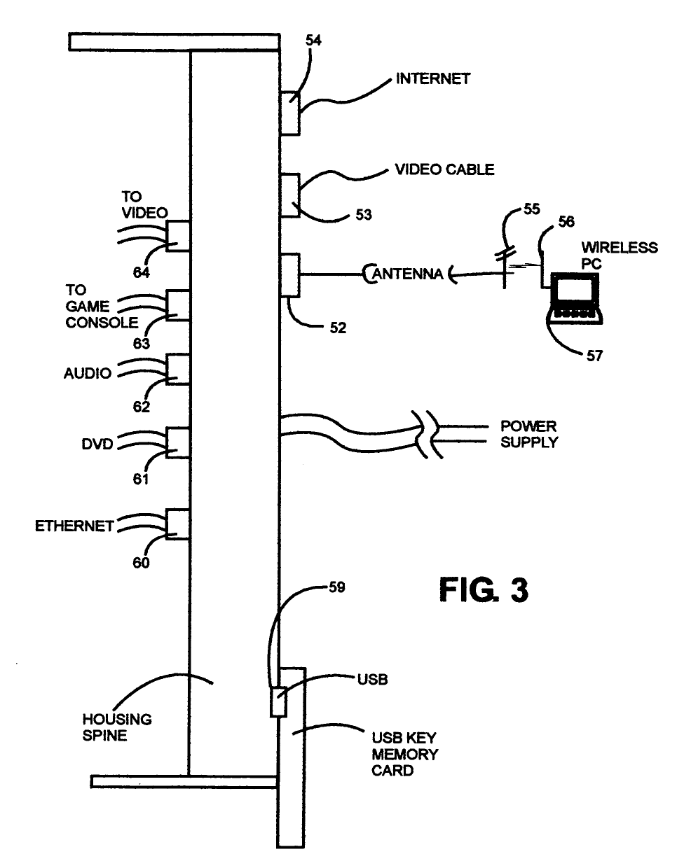

Referring now to FIG. 3, there is a diagrammatic side section of the rear wall of the housing showing illustrative connections to external and internal outlets from the connection spine. The spine housing 51 has internal outlet connections internally to video 64, to a game console 63, to DVD 61, to audio 62 and to Ethernet 60. The spine 51 has the following external outlets: outlet 54 to Internet, video cable outlet 53, antenna outlet 52 to antenna 55 transceiving to antenna 56 of wireless connected PC 57 that may be used to remotely control functions within the consumer home entertainment center, an outlet to power supply chord 58 and an outlet 59, i.e. it is an USB outlet connected to USB memory key 60 with, for example a set of photographs taken with a digital camera and stored in the memory key card.

Although certain preferred embodiments have been shown and described, it will be understood that many changes and modifications may be made therein without departing from the scope and intent of the appended claims.

What is claimed is:

1. A consumer electronic entertainment center comprising:
a housing adapted to removably support a plurality of different consumer electronic products;
a plurality of external I/O connection outlets of different types in said housing; and
a connections spine in said housing including:
a plurality of I/O connection outlets of different types;
a plurality of electrical connector paths for connecting pairs of said outlets in said spine with each other;
a plurality electrical connector paths for connecting one of said outlets in said spine with one of said external outlets in said housing; and
at least one converter in at least one of said electrical connector paths for converting an electrical signal input to one of said outlets of said connector path into a different electrical signal output from the other outlet of said connector path.

2. The consumer electronic entertainment center of claim 1 further including:
an audio receiver supported within said housing;
at least one of said electrical connector paths connecting an outlet connected to said audio receiver with one of said external outlets; and
a plurality of said electrical connector paths connecting outlets connected to said audio receiver respectively to outlets connected to other consumer electronic products supported within said housing.

3. The consumer electronic entertainment center of claim 1 further including:
a video receiver supported within said housing;
at least one of said electrical connector paths connecting an outlet connected to said video receiver with one of said external outlets; and
a plurality of said electrical connector paths connecting outlets connected to said video receiver respectively to outlets connected to other consumer electronic products supported within said housing.

4. The consumer electronic entertainment center of claim 2 wherein said one of said external outlets connected to said outlet connected to said audio receiver is in turn connected to an RF antenna.

5. The consumer electronic entertainment center of claim 3 wherein said one of said external outlets connected to said outlet connected to said video receiver is in turn connected to an RF antenna.

6. The consumer electronic entertainment center of claim 3 wherein at least one of said electrical connector paths for connecting pairs of said outlets in said spine with each other connects outlets of different types.

7. The consumer electronic entertainment center of claim 3 wherein at least one of said electrical connector paths for connecting one of said outlets in said spine with one of said external outlets in said housing connects outlets of different types.

8. The consumer electronic entertainment center of claim 6 further including, in the connector path connecting said pairs of outlets, a converter converting the connector path operable with the first outlet into a connector path operable with the second different outlet.

9. The consumer electronic entertainment center of claim 7 further including, in the connector path connecting said outlet in said spine with an external outlet, a converter converting the connector path operable with the outlet in said spine into a connector path operable with said external different outlet.

10. The consumer electronic entertainment center of claim 1 further including:
an electronic game console supported within said housing; and
at least one of said electrical connector paths connecting an outlet connected to said game console to an outlet connected to another consumer electronic product supported within said housing.

11. The consumer electronic entertainment center of claim 10 wherein said another consumer electronic product supported in said housing is a video display unit.

12. The consumer electronic entertainment center of claim 11 wherein said game console is connected to said video display unit through a sequence of connector paths including a video receiver supported within said housing.

13. The consumer electronic entertainment center of claim 1 further including, in at least one of the connector paths, a converter for converting a signal input into an outlet in one of the connector paths into a different signal output from the other outlet in said connector path.

14. The consumer electronic entertainment center of claim 13 wherein said at least one connector path including said converter has an external outlet connected to a power supply.

15. The consumer electronic entertainment center of claim 1 wherein said at least one connector path has an external outlet connected to an external computer whereby said external computer is enabled to control functions within said entertainment center.

16. The consumer electronic entertainment center of claim 15 further including:
an antenna connected to said external outlet; and
means for wirelessly connecting an external wireless computer to said external outlet.

17. The consumer electronic entertainment center of claim 1 wherein at least one of said outlets in at least one of said electrical connector paths is connected to several outlets in said connector path.
